(19) United States
(12) Patent Application Publication
(10) Pub. No.: US 2022/0374757 A1
(43) Pub. Date: Nov. 24, 2022

(54) EFFICIENT COMPUTATION OF HAMILTONIANS FOR ISING PROCESSORS

(71) Applicant: RESERVOIR LABS, INC., New York, NY (US)

(72) Inventors: Pierre-David LETOURNEAU, Philadelphia, PA (US); Matthew Harper LANGSTON, Beacon, NY (US); Noah Isaac AMSEL, New York, NY (US); RIchard LETHIN, New York, NY (US)

(21) Appl. No.: 17/735,038

(22) Filed: May 2, 2022

Related U.S. Application Data
(60) Provisional application No. 63/182,558, filed on Apr. 30, 2021.
(60) Provisional application No. 63/183,557, filed on May 3, 2021.

(51) Int. Cl. G06N 10/60; G06F 30/20

(52) U.S. Cl. CPC G06N 10/60; G06F 30/20; G06F 2111/10

(57) ABSTRACT

A processor-implemented method includes receiving, as input, an array of values characterizing a polynomial feasibility problem representing a physical system for solving a computational problem. The method also includes reducing dimensions of the polynomial feasibility problem by transforming the polynomial feasibility problem into a high-dimensional linear feasibility problem and a non-linear feasibility problem. The method further includes solving the high-dimensional linear feasibility problem to obtain a first set of interim solutions. The method includes solving the non-linear feasibility problem based on the first set of interim solutions to obtain a result of the non-linear feasibility problem. The method also includes outputting parameters characterizing the physical system, with a ground state corresponding to an output solution of the computational problem based on the result obtained from solving the non-linear feasibility problem.

### CROSS-REFERENCE TO RELATED APPLICATION

The present application claims the benefit of U.S. Provisional Patent Application No. 63/182,558, filed on Apr. 30, 2021, and titled “OPTIMIZATION TECHNIQUES, FM-GPS, PARFAITE, sMFFT,” and U.S. Provisional Patent Application No. 63/183,557, filed on May 3, 2021, and titled “EFFICIENT COMPUTATION OF HAMILTONIANS FOR ISING PROCESSORS,” the disclosures of which are expressly incorporated by reference in their entireties.

### FIELD OF THE DISCLOSURE

Aspects of the present disclosure generally relate to computing Hamiltonians for Ising processors, and more specifically to identifying Hamiltonian parameters for computations, such as multi-bit additions and multiplications, as well as Boolean circuit operations.

### BACKGROUND

The Ising model comes from statistical mechanics, where the Ising model illustrates how certain macroscopy properties (e.g., phase transitions) can arise from simple low-level models. It has been known for some time that statistical mechanics systems, such as the Ising model, can also solve certain computing problems such as decoding, image restoration, associative memory, learning, and optimization. For certain problems, forming an optimal Ising system for a problem involves highly complex polynomial feasibility problems, which may include global, non-convex optimization problems. The energy of an Ising model configuration may be represented by a Hamiltonian function with variables that can be in one of two states. The states may be represented as {−1,1} (or {0,1} in a digital system) and may correspond to spin, where −1 indicates a spin in a first direction and 1 indicates a spin in the opposite direction.

One problem that an Ising system might solve could be to search for optimal solutions to a Boolean logic or arithmetic function when partial information about some inputs or outputs is known. Take, for example, an arithmetic problem of multi-bit multiplications. Unfortunately, existing techniques are limited for designing an Ising system for multi-bit multiplication. Finding an optimal Ising system for multi-bit operations (e.g., Boolean operations or floating-point multiplication operations) may be designed to be represented as polynomial feasibility problems. It would be desirable to have a computationally efficient technique for solving these polynomial feasibility problems to design useful systems for Ising model applications.

### SUMMARY

In aspects of the present disclosure, a processor-implemented method includes receiving, as input, an array of values characterizing a polynomial feasibility problem representing a physical system for solving a computational problem. The method also includes reducing dimensions of the polynomial feasibility problem by transforming the polynomial feasibility problem into a high-dimensional linear feasibility problem and a non-linear feasibility problem. The method further includes solving the high-dimensional linear feasibility problem to obtain a first set of interim solutions. The method also includes solving the non-linear feasibility problem based on the first set of interim solutions to obtain a result of the non-linear feasibility problem. The method also includes outputting parameters characterizing the physical system, with a ground state corresponding to an output solution of the computational problem based on the result obtained from solving the non-linear feasibility problem.

Other aspects of the present disclosure are directed to an apparatus. The apparatus has a memory and one or more processor(s) coupled to the memory. The processor(s) is configured to receive, as input, an array of values characterizing a polynomial feasibility problem representing a physical system for solving a computational problem. The processor(s) is also configured to reduce dimensions of the polynomial feasibility problem by transforming the polynomial feasibility problem into a high-dimensional linear feasibility problem and a non-linear feasibility problem. The processor(s) is further configured to solve the high-dimensional linear feasibility problem to obtain a first set of interim solutions. The processor(s) is also configured to solve the non-linear feasibility problem based on the first set of interim solutions to obtain a result of the non-linear feasibility problem. The processor(s) is configured to output parameters characterizing the physical system, with a ground state corresponding to an output solution of the computational problem based on the result obtained from solving the non-linear feasibility problem.

Other aspects of the present disclosure are directed to an apparatus. The apparatus includes means for receiving, as input, an array of values characterizing a polynomial feasibility problem representing a physical system for solving a computational problem. The apparatus also includes means for reducing dimensions of the polynomial feasibility problem by transforming the polynomial feasibility problem into a high-dimensional linear feasibility problem and a non-linear feasibility problem. The apparatus further includes means for solving the high-dimensional linear feasibility problem to obtain a first set of interim solutions. The apparatus also includes means for solving the non-linear feasibility problem based on the first set of interim solutions to obtain a result of the non-linear feasibility problem. The apparatus includes means for outputting parameters characterizing the physical system, with a ground state corresponding to an output solution of the computational problem based on the result obtained from solving the non-linear feasibility problem.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 illustrates a graph with respect to a max-cut problem.

FIG. 5 illustrates a three-dimensional view of a global search space with multiple local minima.

FIGS. 6A and 6B illustrate examples of hierarchal polynomials, in accordance with aspects of the present disclosure.

FIG. 7 is a block diagram illustrating an example fast-multidimensional global polynomial solver (FM-GPS) processor-based system, in accordance with aspects of the present disclosure.

FIGS. 8A and 8B illustrate Ising spin-glass models, without and with auxiliary variables, respectively, in accordance with aspects of the present disclosure.

FIG. 9 is a block diagram illustrating an approach for solving an Ising system, in accordance with aspects of the present disclosure.

FIG. 10 is a block diagram illustrating solving of a high-dimensional linear feasibility problem with linear programs, in accordance with aspects of the present disclosure.

FIG. 11 illustrates a method for computing parameters for a physical system, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described above, the Ising model comes from statistical mechanics, where the Ising model illustrates how certain macroscopy properties (e.g., phase transitions) can arise from simple low-level models. The energy of an Ising model configuration may be represented by a Hamiltonian function with variables that can be in one of two states. The states may correspond to spin, where −1 indicates a spin in a first direction and 1 indicates a spin in the opposite direction.

One problem that an Ising system might solve could be to search for optimal solutions to a Boolean logic or arithmetic function when partial information about some inputs or outputs is known. Take, for example, an arithmetic problem of multi-bit multiplications. Unfortunately, existing techniques are limited for designing an Ising system for multi-bit multiplication due to potential computational intractability inherent in the size of the problem required for practical applications. Finding an optimal Ising system for multi-bit multiplication can be designed to involve polynomial feasibility problems. Aspects of the present disclosure are directed to a computationally efficient technique for solving these polynomial feasibility problems to design useful systems for Ising model applications, avoiding the intractability of prior approaches.

In some aspects of the present disclosure, a non-convex global polynomial optimizer may be applied in combination with linear programming techniques and dimension-reduction techniques to identify appropriate Hamiltonian parameters for obtaining optimal Ising spin-glass Hamiltonians in performing Boolean logic operations and arithmetic functions. These aspects provide a platform for creating optimal Hamiltonians for other kinds of circuits, reflecting more complex Ising architecture constraints and algorithm objectives.

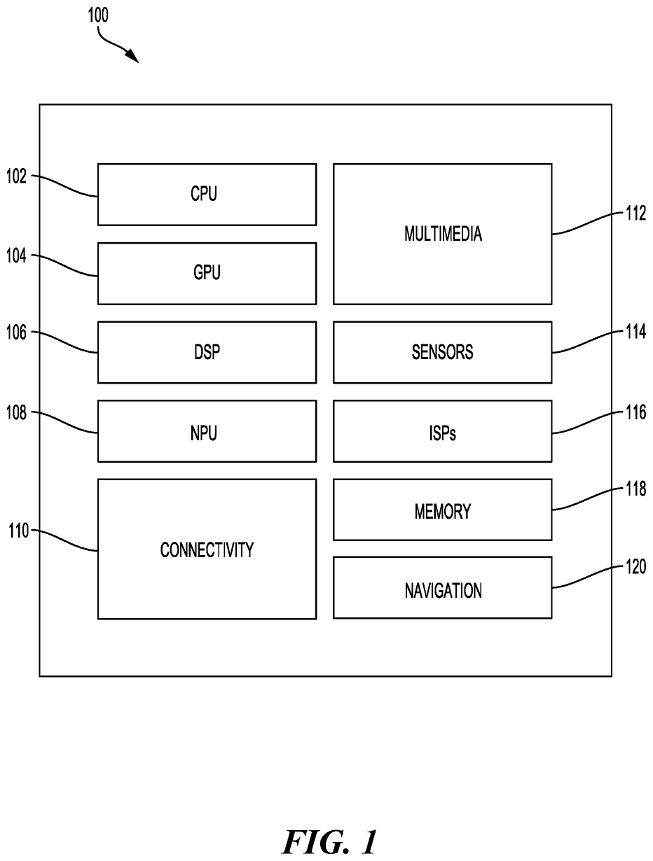

FIG. 1 illustrates an example implementation of a system-on-a-chip (SOC) 100, which may include a central processing unit (CPU) 102 or a multi-core CPU configured for solving an Ising system. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive, as input, an array of values characterizing a polynomial feasibility problem representing a physical system for solving a computational problem. The general-purpose processor 102 may also include code to reduce dimensions of the polynomial feasibility problem by transforming the polynomial feasibility problem into a high-dimensional linear feasibility problem and a non-linear feasibility problem. The general-purpose processor 102 may also include code to solve the high-dimensional linear feasibility problem to obtain a first set of interim solutions. The general-purpose processor 102 may also include code to solve the non-linear feasibility problem based on the first set of interim solutions to obtain a result of the non-linear feasibility problem. The general-purpose processor 102 may also include code to output parameters characterizing the physical system, with a ground state corresponding to an output solution of the computational problem based on the result obtained from solving the non-linear feasibility problem.

The instructions compute bit-level operations (e.g., Boolean operations such as AND, OR, XOR, as well as multi-bit algebraic operations, such as addition and multiplication). These operations form the foundation for any computational framework. The ability to perform them efficiently is desired for any well-designed computational model.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

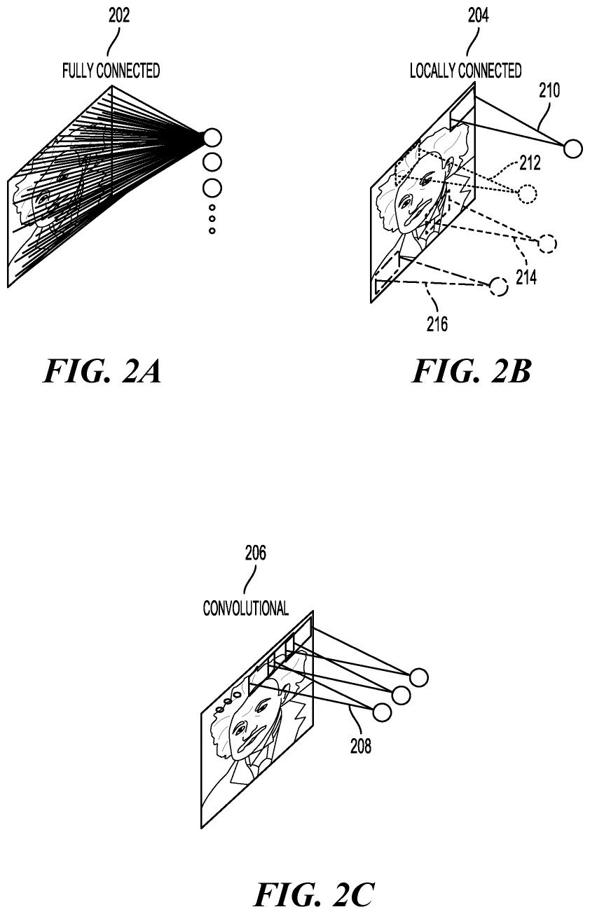

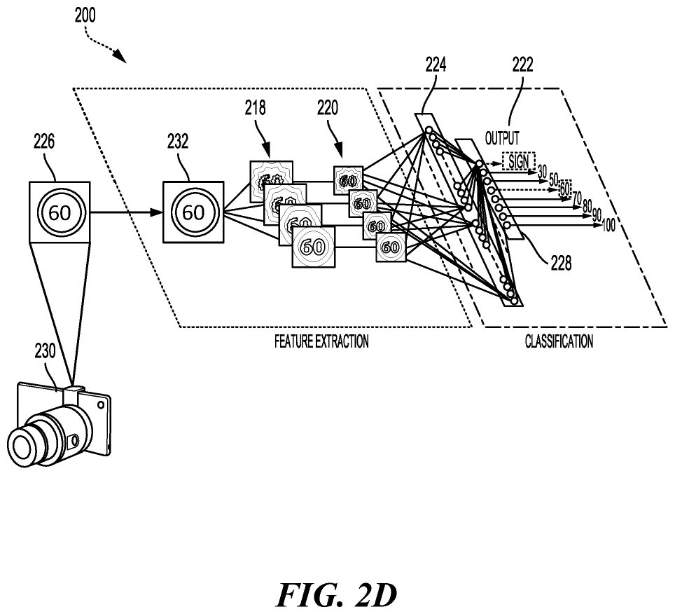

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

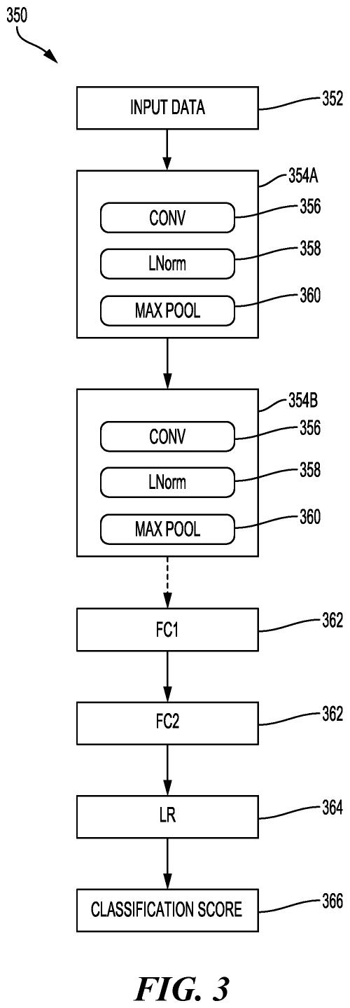

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

Entire neural networks (or portions of the neural networks) may be modeled as sets of polynomials. These polynomials may be trained using computational problems formulated as global, non-convex optimizations, as seen in the following equation:

$${min}_{x ∈ {ℝ}^{D}} p ( x ) \qquad ( 1 )$$

Subject to constraints: qₙ,(x)≥0, n=1,2, . . . , N rₘ(x)=0,m=1,2, . . . , M,

where x∈ [symbol] ^{D} is the optimization variable, p(x)=Σ_{|n|≤d}pₙTₙ(x) is a polynomial objective function ({Tₙ(x)} and d being a polynomial basis and polynomial degree, respectively), and {qₙ(x)},{rₘ(x)} are polynomial constraints. Table 1 highlights several examples of non-convex optimization problems, together with their corresponding explicit objectives and constraints.

TABLE 1
Non-Convex

| Optimization | | Constraints | |
|---|---|---|---|
| Problem | Objective | Inequality | Equality |
| Mixed Integer | c^{T} x | aₙ^{T}x + bₙ, x | cos(2πxₙ_{ᵢ}) |
| Linear Program | | | |
| (MILP) | | | |
| Quadratically- | x^{T} Ax + b^{T} x | x^{T} Aₙx + bₙ^{T}x + | aₙ^{T}x − bₙ |
| Constrained | | cₙ | |
| Quadratic | | | |
| Program (QCQP) | | | |
| Non-linear | f(x) (non- | qₙ(x) (non- | Tₘ(x) (non- |
| Program (NLP) | linear) | linear) | linear) |

An example model corresponding to Equation (1) is a max-cut model. The max-cut problem consists into finding a set of edges that separates the vertices of a graph into two disjoint sets (cut) such that the sum of the weights of the selected set of edges is maximized. The max-cut problem can be formulated as an optimization problem of the form,

$$Maximize {\sum }_{n . m} {w}_{n , m} ( \frac{1 - {x}_{n} {x}_{m}}{2} ) \qquad ( 2 )$$

Subject to xₙ∈{−1,1}

where w_{n,m} is the weight of an edge connecting vertices xₙ and xₘ and xₙxₘ may be the product of the values of the vertices.

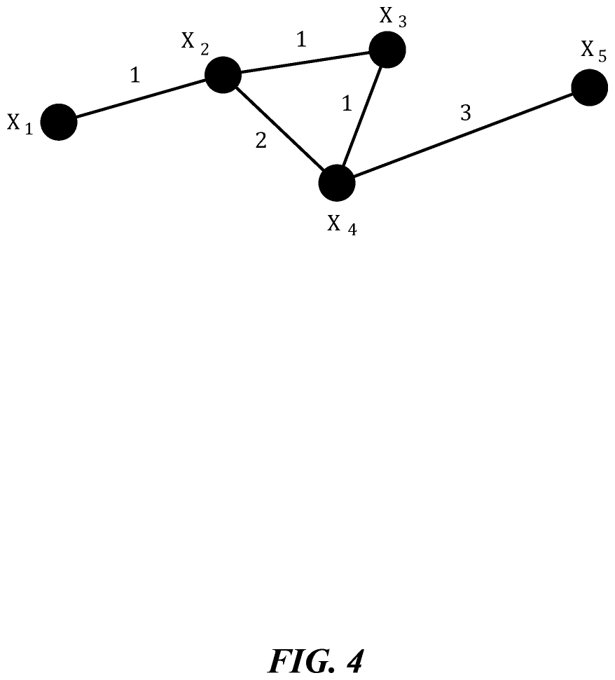

FIG. 4 illustrates a graph with respect to a max-cut problem. For the example shown in FIG. 4, the max-cut problem corresponds to:

$$Maximize ( \frac{1 - {x}_{1} {x}_{2}}{2} ) + ( \frac{1 - {x}_{2} {x}_{3}}{2} ) + 2 ( \frac{1 - {x}_{2} {x}_{4}}{2} ) + ( \frac{1 - {x}_{3} {x}_{4}}{2} ) + 3 ( \frac{1 - {x}_{4} {x}_{5}}{2} ) \qquad ( 3 )$$

Subject to x₁, x₂, x₃, x₄, x₅ E

The max-cut problem is a discrete optimization problem because the variables are constrained to the values +/−1. However, as with most combinatorial optimization problem, the max-cut problem can be re-formulated exactly as a polynomial optimization problem by re-writing the constraints as:

xₙ ∈{−1,1}→xₙ²−1=0 (4)

which corresponds to a polynomial equality constraint, and leads to a polynomial optimization problem because the objective corresponds to a polynomial.

These problems may be represented in the continuous space for applications, such as artificial intelligence (AI), deep learning, machine learning, scientific computing, engineering design, and optimal control. The problems may be represented in a discrete space for applications, such as logistics and planning, scheduling, and resource allocation. Mixed space applications may include software verification, combinatorial optimization, graph analysis, and protocol certification.

Global, non-convex optimization problems are global in the sense that a global minimum should be found over the entire search space. The optimization problems are non-convex because local minima may not be global, and they provide no information about the global minima.

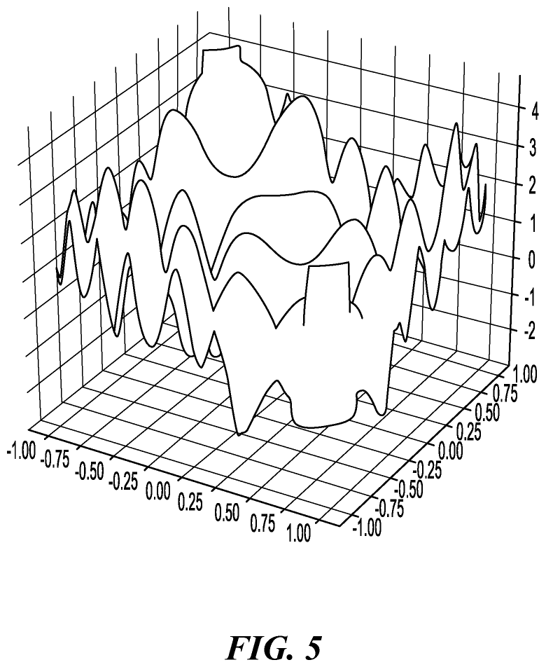

FIG. 5 illustrates a three-dimensional view of a global search space with multiple local minima. FIG. 5 shows the difficulties that may be encountered with finding a global minimum. In the hyper cube of FIG. 5, the function has two global minima and multiple local minima. The function shown in FIG. 5 is f(x)=x²=y²+sin(5π(x²+y²))+sin(π(xy))+sin(2π(xy)²), which is minimized over the hypercube.

As seen in FIG. 5, the current methods (e.g., gradient descent) are highly dependent on the starting point, and will only reach local minima. That is, depending on where the process starts, the process can only descend so much without ascending. Such local minima can be highly suboptimal, especially in high dimension.

Existing techniques for solving these optimization problems offer a disadvantageous trade-off between guarantees of global optimality (e.g., finding a global optimum) and scalability. For example, local and convexity based solutions, such as gradient descent and Newton/quasi-Newton solutions, do not guarantee global optimality, with issues arising at saddle points. These solutions have advantages, such as working with scalable polynomials and being efficient on convex problems. Global probabilistic/deterministic techniques, such as a Monte Carlo Markov chain, simulated annealing/branch and bound techniques, and exhaustive searches, scale exponentially, although they may guarantee global optimality. It would be desirable to have a high-performance technique and novel system for efficiently solving large-scale multidimensional global, non-convex optimization problems.

Aspects of the present disclosure introduce a fast-multidimensional global polynomial solver (FM-GPS) that performs semi-definite convex relaxations of constrained polynomial optimization problems, as seen in the following equation:

$${min}_{\{ {μ}_{n} \}} {p}_{n} {μ}_{n} \qquad ( 5 )$$

subject to M(μₙ)≥0
   where {pₙ} are the

$$( \begin{matrix}D + d \\ d\end{matrix} )$$

polynomial coefficients of the degree-d polynomial p(x) in D dimensions (where

$$( \begin{matrix}D + d \\ d\end{matrix} )$$

means D+d choose d), M(μₙis a (moment) matrix with explicit form specific to the semi-definite program (SDP) relaxation and ≥0 indicates positive-definiteness. The matrix M(μₙ) is an N×N, highly-structured matrix with N degrees of freedom (rather than N² as in the general case). The size of N dictates the processing cost of solving the SDP (and by extension, the cost of solving the original non-convex optimization problem). It may be sufficient to pick N only slightly larger than the number of coefficients. In some examples, it may be sufficient to pick

$$N = ( \begin{matrix}D + {C ( ϵ )}^{d} \\ {C ( ϵ )}^{d}\end{matrix} ) ,$$

where C(ϵ) is a constant that is independent of dimension, depending only on the desired accuracy ϵ. While existing theoretical estimates are super-exponential in dimension and degree, it is estimated that N scales at most as a dimension-based polynomial. In some aspects, Chebyshev polynomials are used as the basis {Tₙ (x)} for numerical stability and performance. The FM-GPS obtains an optimal value and optimal location recovery, even in the presence of multiple global minima.

According to aspects of the present disclosure, the FM-GPS employs a novel algebraic sampling of the optimization landscape followed by a convex relaxation. The technique uses relaxation approaches that enable low-complexity sampling to provide information about the location and value of the global optimum while efficiently performing a typically computationally-prohibitive (e.g., potentially intractable) full exploration of the entire space.

This solution is scalable with provable polynomial scalability. In other words, the FM-GPS possesses provable efficient (e.g., polynomial) computational bounds that are significantly better than existing techniques. The FM-GPS guarantees global optimality. That is, the FM-GPS provides deterministic guarantees of global optimality (e.g., value and location) within a prescribed user-specified error level. This is in contrast to random techniques (e.g., Monte Carlo Markov chain), and non-random techniques that are computationally expensive or limited to local optima.

The FM-GPS is versatile and broadly applicable. That is, the solution works with a complex non-convex objective and constraints (e.g., discrete sets, disconnected components, non-convex domains), as well as with a continuous objective. The FM-GPS solution is a high-performance, scalable implementation.

The fast-multidimensional global polynomial solver (FM-GPS) exploits structural properties unique to semi-definite program (SDP) solver relaxations to produce a scalable SDP and global non-convex optimization solver. Exploitable structures include a sparsity and hierarchical structure, a block Hankel-plus-Toeplitz structure, a low-rank structure, and an underlying geometry structure. The solving may further include dimensionality reduction, and/or using a warm start. Of course, other structures may be exploitable, beyond what is listed here.

With respect to sparsity and hierarchy, many practical problems exhibit chordal sparsity, coefficient sparsity and/or a hierarchical structure (e.g., Neural/Bayesian networks). These structures may be used to reduce the size and cost of enforcing semi-definite constraints. For a block Hankel-plus-Toeplitz structure, the matrix M(p) possesses only N degrees of freedom together with a Hankel-plus-Toeplitz block structure that may be used to significantly speed up the computation of eigenvalue decompositions through fast matrix-vector products (e.g., iterative techniques) and randomized linear algebra. A low-rank structure may be exploited because optimal matrices are rank-1 (e.g., moment matrices of a Dirac delta). Performance may be gained by restricting the search to low-rank points and may accelerate the eigenvalue decomposition. Low-rank-based penalties may also be used to increase convergence rates. Optimal sets may have dimensions bounded by the minimum between N and total number of global optima of the original problem. This characteristic may be used to reduce the dimensionality. Facial reduction may also be used to achieve a similar goal.

To enable a warm start, the SDP may be approximated to various degrees by linear programs (LPs) and second-order cone programs (SOCPs), either statically or adaptively. Efficient numerical solvers may treat the approximate problems leading to a warm start for the SDP.

The underlying geometric structure may be exploited because the geometry of convex relaxation SDPs is closely associated with that of the original problem. Such knowledge may be used to inform the solution of the convex relaxation, e.g., large and flat optimal region.

The fast-multidimensional global polynomial solver (FM-GPS) provides significant improvements to existing applications, such as electronic design automation (EDA), software verification, planning, and cryptography. The FM-GPS enables the solving of very large problems, such as the training of neural networks, millions of times faster with greater accuracy than is currently possible today with existing heuristics. Because problems, such as those in AI and machine learning (ML), are framed as optimization (e.g., optimizing the weights of a deep learning neural network to minimize the error for inferences on a training set), this may result in ML systems that can learn millions of times faster than today's systems. Improvements in optimization can further benefit many other fields, such as engineering design in aerospace.

The FM-GPS reduces problems in the domain to polynomial optimization, a form in which the global optimum can be rapidly identified. FM-GPS is a high-performance semi-definite program (SDP) solver that provides significant computational cost reductions/speedups, as well as lower memory requirements (e.g., approximately 10 times to 1000 times lower). The FM-GPS is able to perform convex relaxations for matrix completion and recommender systems, sum of squares (SOS) programs for control, and very large scale integration (VLSI) design. The FM-GPS offers high-fidelity and globally optimal solutions, including sparse deep neural networks, high-performance graph algorithms, and guaranteed optimal control strategies and optimal design. The FM-GPS provides discrete optimization, orders-of-magnitude beyond existing scales for integer and mixed integer programming, logistics, planning, and scheduling. The FM-GPS provides an efficient approximation of non-deterministic polynomial (NP)-hard problems, such as quadratically-constrained quadratic programs (QCQP), and discrete optimization, such as combinatorial optimization and graph problems (e.g., vertex coloring, max-cut), etc. The FM-GPS also reformulates existing problems, such as non-linear inverse problems (e.g., imaging), quantum chromodynamics (QCD), etc., as well as fast bounding schemes for existing branch and bound (B&B) algorithms. The FM-GPS works well with global optimization problems such as integer programming, e.g., software verification and certification, such as with a software defined radio (SDR). For non-linear optimization, the FM-GPS has applications in material design and machine learning, scientific computing and simulations, imaging and positioning, and numerical analysis. Partial differential equation (PDE) constrained optimization, control systems and robotics, data science, and network design and maintenance also fall within the realm of non-convex optimization problems.

In some aspects, the FM-GPS is based on the mathematical Lasserre framework. In these aspects, the FM-GPS approximates general global optimization problems by global polynomial optimization problems, which are translated into equivalent (convex) semi-definite programs (SDP) that can be solved efficiently using existing technology. Global polynomial optimization, however, in its greatest generality, is NP-hard. Nonetheless, the relaxation from the global polynomial optimization to the SDP can be performed in a highly computationally-efficient manner for a broad class of problems (e.g., a compact subset on the hypercube; in some aspects, an arbitrary compact semi-algebraic set may replace the hypercube). The FM-GPS guarantees global optimality together with lower computational costs than existing techniques. Given its advantageous scaling, stability, low cost, global optimality, and modular software design, FM-GPS opens the door to the study of optimization problems that were previously considered intractable, in addition to providing the capability of solving existing problems at a fraction of the cost of existing techniques.

As described above, the FM-GPS optimization technology tool consists of processes for solving non-convex, constrained optimization problems. Aspects of the present disclosure provide an efficient convex relaxation of the problem seen in Equation (1), by which it is reformulated to take the form of a semi-definite program (SDP):

$${min}_{\{ {u}_{n} \}} {p}_{n} {μ}_{n} \qquad ( 5 )$$

subject to M(μₙ)≥0

When the reformulation is performed appropriately, any optimal value {μ*ₙ} of the SDP provides information about the value and the location of min p(x) within the constrained set.

The technique scales as follows: first, regular multidimensional functions may be represented efficiently using polynomial expansions. For instance, in the case of an analytic function, a Chebyshev expansion with maximum Euclidean degree d=O(log(ϵ)) (independent of dimension) is sufficient for obtaining an ϵ-accurate approximation ∥·∥_{∞}-norm independently of dimension, where ∥·∥_{∞}-norm corresponds to the maximum of the absolute value of the function on its domain. In particular, this implies that the number of coefficients is polynomial in dimension.

Second, computing the Chebyshev polynomial coefficients of a function is a numerically stable linear operation. Thus, one only needs to know approximately as many function values as coefficients in order to compute them. Therefore, only polynomially many (e.g., in dimension) function values are necessary in order to interpolate a regular function accurately in ∥·∥_{∞}-norm. Computing those function values corresponds to exploring the entire landscape.

Third, once polynomial coefficients have been computed, the FM-GPS can find the location of a global optimum. In the case of neural networks, the SDP has the following characteristics: the total number of weights in the network corresponds to the dimension of the full problem; weights deeper in the network have a higher associated polynomial degree in the objective that grows linearly with depth; and the size of the data does not affect the size of the SDP (neither the dimension, nor the degree of the interpolant). In the case of an additive training function of the form:

$$e ( w ) := {\sum }_{n = 1}^{N} ρ ( {X}_{n} ; w ) , \qquad ( 6 )$$

where p(xₙ; w) represents the training error at data point xₙ for weights w, the algorithm scales linearly on the number of data points N. In particular, objective function evaluation can be carried out once in parallel because the interpolations points {wₖ} are known a priori (computing p(xₙ; wₖ) is parallel in n and k).

In some aspects of the present disclosure, the FM-GPS builds on recently-developed technology from Lasserre, but offers significant improvements, including the following characteristics, which allow the FM-GPS to surpass existing techniques and are key to tackling global optimization problems efficiently and at practical scales. The improvements include advantageous scaling, in other words, possessing provably efficient computational bounds that are significantly better than existing techniques. The advantages of FM-GPS in computational bounds are asymptotic, so as the problem size grows, the advantage grows. Speedups of 1,000,000 times are possible with the FM-GPS techniques.

Another improvement of the FM-GPS is global optimality, such that output is guaranteed to be within a prescribed error of the true solution. The FM-GPS outperforms currently-existing techniques that are either computationally expensive or restricted to local optima. Another improvement, optimal location, computes both the optimal value and an optimal location. Current techniques are limited to computing the optimal value, and can find an optimal location only if stringent conditions are satisfied.

The improvement of numerical stability allows the FM-GPS to solve problems of an arbitrary large degree (e.g., objective and constraints). Finally, software performance is improved such that existing, powerful convex optimization technology can be leveraged and tailored to produce a high-performance implementation.

The FM-GPS method generally relies on an efficient SDP solver as its computational backbone. Unfortunately, existing solvers suffer from both instability issues and disadvantageous scaling. The reasons underlying these issues are numerous, but can be classified into three main categories: 1) the generality-specialization trade-off, 2) a memory bottleneck, and 3) problem size. Each is described below, along with differences between the problems targeted by these existing solvers and the problem at hand. Specifically, SDPs associated with polynomial optimization problems possess much more structure than the general case considered by existing solvers. This structure can be leveraged to create specialized solvers that are both more stable and orders-of-magnitudes faster than those currently available.

The generality-specialization trade-off occurs because existing solvers are designed with broad applicability in mind and cannot leverage the structure of specific problems for the most part. The high cost associated with existing solvers may be overcome in the context of polynomial optimization in a variety of ways that involve leveraging the special structure, including: the block Hankel-plus-Toeplitz structure of the moment matrix; the existence and/or search for low-rank solutions, and a linear programming (LP) warm start.

The memory bottleneck occurs because many existing solvers are second order and rely on the knowledge of the Hessian, which consumes a large amount of storage and is often not tractable large scale. The high cost associated with a second-order solver may be significantly lowered through the use of first-order solvers (e.g., projected gradient descent). These have the advantage of only specifying knowledge of the value of the optimization functional and its gradient, both of which are known analytically due to the linear nature of the functional. Further, first-order solvers do not store or compute a large Hessian matrix, an operation which may carry a cost as high as O(N²).

Current solvers may only handle problems with 10³ variables. A polynomial optimization problem's size, however, scales polynomially in dimension. Although this scaling is highly-advantageous when compared with other global optimization schemes providing guarantees of global optimality (e.g., naive search), this characteristic significantly reduces the reach of existing techniques. Problem size is a fundamental issue associated with dense polynomial optimization. Dense means that all coefficients associated with basis polynomials of degree at most d, are non-zero. The problem size may be overcome through the use of hierarchical polynomials. Hierarchical polynomials are a family of polynomials that possess a hierarchical structure associated with a function composition reminiscent of neural networks, but with polynomial activation functions.

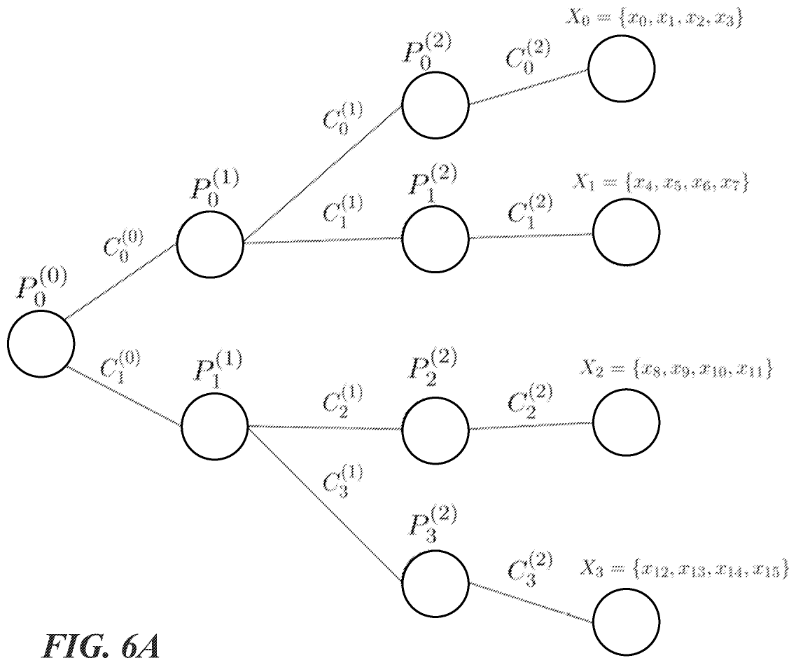

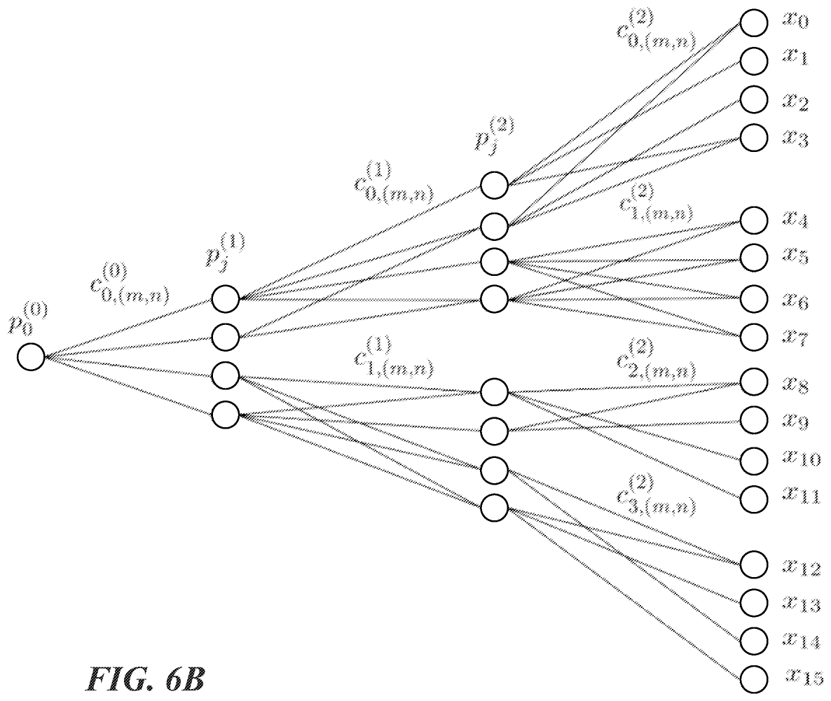

FIGS. 6A and 6B illustrate examples of hierarchal polynomials, in accordance with aspects of the present disclosure. FIG. 6A illustrates an analytical representation at a macroscopic level. FIG. 6B illustrates a graphical representation at a microscopic level where each edge in FIG. 6A has been expanded to show a dependence on each scalar input/output. Hierarchical polynomial-based optimization relies on “unwrapping” this hierarchical structure to break a large global optimization problem into a sequence of much smaller, more manageable problems, as seen in the following equation:

p₀⁽⁰⁾(Σₖ_{₁}C_{0,(k}_{₀}_{,k}_{₁}₎⁽¹⁾pₖ_{₁}⁽¹⁾( . . . Σₖ_{_{L−1}}C_{jL-1,(k}_{_{L−2,}}ₖ_{_{L−1)}}^{(L-1)}pₖ_{_{L−1}}^{(L-1)}(Σₖ_{_{L}}^{I}^{_{L}}C_{jL,(k}_{_{L−1,}}ₖ_{_{L}}₎^{(L)}xₖ_{_{L}}^{(L)}))) (7)

In FIGS. 6A and 6B, the nodes are vector polynomial functions (FIG. 6A) P₀, P₁, P₂, and P₃ taking a vector input and outputting vectors, or scalar polynomials (FIG. 6B) p₀ taking a scalar input and outputting a scalar. The edges indicate composition, e.g., the output of a node is the input of a connected node if there is an edge between the two. The quantities C0, C1, C2, . . . CL are linear transformations, e.g., matrices. The parameters xₒ, x₁, . . . are inputs to the neural network and the elements of the matrices C are the parameters, also referred to as weights. In training, the weights are allowed to vary, and the total function is a polynomial with variables corresponding to the weights. The parameter L represents the number of layers, in other words, the depth of the composition. The parameters (m,n) seen in FIG. 6B correspond to the sub-indices {kL−1, kL−j} in Equation (7), although (m,n) correspond to elements in the matrix C. In FIG. 6B each actual edge in the neural network is shown with a single weight associated with a corresponding matrix element. All explicit indices are not shown to avoid cluttering the figure. That is, the notation in FIG. 6B is descriptive rather than explanatory.

The issues of current solvers may be addressed by improving computational capabilities by developing SDP solvers, designed specifically for FM-GPS. Moreover, a search strategy based on “space-filling curves” may be used to tailor the dimensionality of the problem to be better suited to strengths of the FM-GPS. Finally, combination strategies may be employed, including using FM-GPS to quickly locate a global basin of attraction and then perform a stochastic gradient descent (SGD) for a local optimal refinement strategy.

Currently, neural networks (NNs) are often trained with an SGD, especially for learning in classification realms, even when regimes are over-parameterized, producing an optimization landscape prone to be exploited by descent techniques. FM-GPS, however, changes the paradigm that is assumed through SGD by changing some of the fundamental, underlying assumptions, including computing a global minimum, removing the need for over parametrization. Moreover, with FM-GPS, it may be possible to achieve levels of accuracy similar to the state-of-the-art and SGD, but with significantly fewer weights by finding a global minimum. If FM-GPS can fit an NN using fewer weights (e.g., fewer degrees of freedom), then less data may be needed. Using fewer weights improves both the training time as well as the inference time (because evaluations become cheaper). In some implementations, it is possible to achieve levels of accuracy similar to the state of the art, but with significantly fewer weights by finding a global minimum.

According to aspects of the present disclosure, the FM-GPS may supplant existing global optimization routines with minimal changes to existing code, due to the modular structure of the FM-GPS. That is, FM-GPS may be implemented as a software tool that specifies little input from the user. An exemplary design consists of three (3) modules: an objective function and parameter specification module, a computational engine, and a visualization and post-processing module.

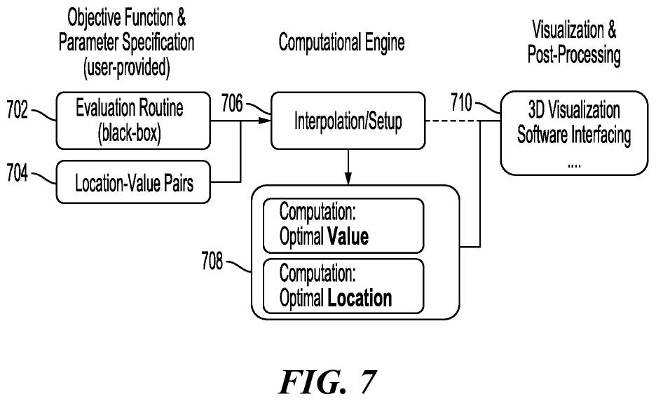

FIG. 7 is a block diagram illustrating an example FM-GPS processor-based system, in accordance with aspects of the present disclosure. The objective function and parameter specification module includes an evaluation routine 702 and a location value pairs module 704. The user-provided box routine takes as inputs points in parameter space and outputs the objective value, or a set of pre-computed location-value pairs characterizing the objective. The user also provides a few parameters specific to the global optimization routine (e.g., maximum number of SDP iterations, desired accuracy, etc.).

The computational engine performs a large percentage of the overall computations of the software tool. The main component is an efficient interpolation sub-routine 706 that translates the user input into the proper format (e.g., SDP), as well as a high-performance SDP solver implementation specifically tailored to our formulation. Outputs of the interpolation sub-routine 706 are received at a module 708. The module 708 computes an optimal value and an optimal location. An optimal value is the smallest value the objective can reach among all feasible points. An optimal location is where this value is achieved, and may not be unique. For instance (x−1)*(x+1) has minimum value over the real numbers equal to 0, but two optimal locations (where this value is achieved) at +1 and −1. The FM-GPS starts by finding the optimal value, and then performs additional steps to find at least one location (e.g., random among all possible optimal locations) where this value is achieved.

The visualization and post-processing module consists of a set of tools made available to the user to examine the computed solution and/or feed the solution to another piece of software for further computations. Examples include visualization tools 710 in low dimensions, as well as an a posteriori solution certification.

Positive polynomials constitute powerful mathematical tools that find many applications in the context of global optimization, control theory, and algebraic geometry, to name but a few. One major question associated with positive polynomials is their representation through sums-of-squares (SOS) polynomials. The interest in this question arises from the fact that multidimensional SOS polynomials, which form a subset of positive polynomials, can be easily characterized through the positive-definiteness of an associated bilinear form through linear matrix inequalities, while a complete and succinct characterization of positive polynomials remains difficult, except in very special cases. In this sense, it is often much more advantageous to work with SOS polynomials than with positive polynomials directly.

It is known that polynomials p(x) positive over compact semi-algebraic sets generated by polynomials constraints g ᵢ(x) can often be represented through a combination of SOS polynomials and algebraic constraints as seen in the following equation (notation described below)

p(x)−σ₀(x)|Σᵢ₌₁^{I}σᵢ(x)gᵢ(x), ∨x∈∩ᵢ₌₁^{I}{xϵ[−1,1]^{D}:gi(x)≥0} (8)

An important result in this regard has been shown by an existence proof for such an exact representation for some properly-chosen SOS polynomials {σᵢ(x))}. Another result in the same category has demonstrated the denseness of sums-of-squares in the ∥·∥₁ coefficient norm in the cone of polynomials non-negative on [−1,1]^{D}. Lasserre further expanded on the latter with a similar denseness result over [symbol] ^{D}, modulo a sums-of-squares perturbation, together with explicit converging sequences. See “A Sum of Squares Approximation of Nonnegative Polynomials,” SIAM review 49.4 (2007) pp. 651-669. Following this, estimates have been introduced on the degree of the sums-of-squares involved in those expressions for polynomials positive over the hypercube and compact semi-algebraic subsets of the hypercube, respectively. These bounds, however, are all at least exponential in the dimension and degree of the positive polynomial.

Aspects of the present disclosure address the problem of efficiently approximating polynomials that are positive over compact semi-algebraic sets through combinations of Sums-Of-Squares (SOS) polynomials and polynomial constraints. New estimates are introduced for the degree required for approximating such polynomials that are significantly more efficient than existing results. In particular, the results can be used to provide polynomial bounds on the complexity of many important computational problems, including problems in algebraic geometry as well as global polynomial optimization.

For all that follows, define [symbol] _{D,d}, 0<d, D∈ [symbol] to be the vector space of multivariate polynomial with real coefficients defined over the D-dimensional hypercube [−1,1]^{D} and having a degree at most d, equipped with the maximum norm, for example:

[symbol]

_{D,d}:={p(x)∈ [symbol] [x]: x∈[−1,1]^{D}, deg(p(x))≤d} (9)

with norm:

$$‖ p ( x ) ‖ = ‖ p ( x ) ‖ {{L}^{∞} [ - 1 , 1 ]}^{D} = {max}_{x ∈ {[ - 1 , 1 ]}^{D}} \vert p ( x ) \vert . \qquad ( 10 )$$

For a fixed, finite set of polynomials {gᵢ(x)}ᵢ₌₁^{I}∈ [symbol] _{D,d}I∈ [symbol] define the compact semi-algebraic set (assumed to be non-empty):

[symbol]

:=∩ᵢ₌₁^{I}{x∈[−1,1]^{D}:gᵢ(x)≥0}. (11)

Refer to the polynomials {gᵢ(x))} as polynomial constraints. The polynomial p(x) is said to be positive (respectively strictly positive) over the semi-algebraic set [symbol] is p(x)≥0 (respectively >) for all x∈ [symbol] . A sums-of-squares (SOS) polynomial belonging to [symbol] _{D,2d} is a polynomial of the form,

$${\sum }_{j = 1}^{J} {( {q}_{j} ( x ) )}^{2} , \qquad ( 12 )$$

for polynomials qᵢ(x)∈ [symbol] _{D,d} and J∈ [symbol] SOS polynomials from a subset (e.g., sub-cone) of the set (e.g., cone) of positive polynomials.

Aspects of the present disclosure rely on the following assumption:

Assumption 1. Consider the non-trivial polynomials p(x), {gᵢ(x)}ᵢ₌₁^{I}∈ [symbol] _{D,d}. Assumption 1 is satisfied if there exists some 0<ϵ*<1 such that p(x)>0 for all x in,

[symbol]

_{ϵ};∩ᵢ₌₁ [symbol] _{ϵ}⁽ⁱ⁾:=∩ᵢ₌₁^{I}{x∈[−1,1]^{D}:gᵢ(x)≥−ϵ}, (13)

and all 0<ϵ≤ϵ*.

Assumption 1 may appear restrictive, but it is not. There always exists a strictly positive number ϵ* such that it holds. This number, which only depends on the specific nature of the polynomials involved, may however be arbitrarily small. In this sense, Assumption 1 makes the dependence of the degree scaling on the properties of the polynomial family explicit, and allows one to compute estimates on a case by case basis.

Theorem 1. If p(x), {gᵢ(x)}ᵢ₌₁^{I}∈ [symbol] _{D,d} satisfy Assumption 1 for some 0<ϵ*<1, then for any 0<ϵ<ϵ*, there exists sum-of-squares polynomials { [symbol] ᵢ²(x))}ᵢ₌₁^{I} and θ²(x) of degrees:

$$deg ( {ς}_{i} ( x ) ) = O ( ξ ( ‖ p ( x ) ‖ , ‖ g ( x ) ‖ , \frac{1}{ϵ} ) deg ( {g}_{i} ( x ) ) ) , i = 1 , … , I \qquad ( 14 )$$

$$deg ( θ ( x ) ) = O ( k ( ‖ p ( x ) ‖ , \{ ‖ {g}_{i} ( x ) ‖ \} , \frac{1}{ϵ} ) max ( {\{ deg ( {g}_{i} ( x ) ) \}}_{i = 1}^{I} , deg ( p ( x ) ) ) )$$

such that,

$$‖ p ( x ) - ( {θ}^{2} ( x ) + {\sum }_{i = 1}^{I} {ζ}_{i}^{2} ( x ) {g}_{i} ( x ) ) ‖ \leq ϵ \qquad ( 15 )$$

where {ξᵢ(·)}ᵢ₌₁^{I} and k(·) are explicit polynomials independent of D and d.

This result states that, under some mild assumption, positive polynomials over compact semi-algebraic sets may be approximated in a pointwise fashion through a combination of SOS polynomials and polynomial constraints. The number of summands involved in the approximation is at most equal to the number of algebraic constraints plus one. Further, given some fixed desired accuracy, the degree of the SOS polynomials is bounded by a quantity proportional to the degree of the original polynomials involved, but is otherwise independent of dimension to a theorem where the bound is super-exponential both in the dimension and the degree of the original polynomials.

Aspects of the present disclosure introduce new quantitative estimates for producing efficient pointwise approximations of polynomials that are positive over compact semi-algebraic subsets of the hypercube through combinations of sums-of-squares polynomials and polynomial constraints. The approximation involves polynomials, which degree is bounded polynomially in the degree of the original polynomial and constraints.

Aspects of the present disclosure are directed to obtaining optimal Ising spin-glass Hamiltonians in performing Boolean circuit operations (e.g., bitwise AND, OR, XOR) as well as bit-level algebraic operations (e.g., multiplication). The Ising model comes from statistical mechanics, where it illustrates how certain macroscopy properties (e.g., phase transitions) can arise from simple low-level models. It has been known for some time that statistical mechanics systems, such as the Ising model, can also solve certain computing problems such as decoding, image restoration, associative memory, learning, and optimization. For certain problems, Ising models can be found in the academic literature. For other problems, forming an optimal Ising system for a problem involves highly complex polynomial feasibility problems, which may also include global, non-convex optimization problems. The energy framework for an Ising modeled system may be represented by a Hamiltonian function with variables that can be in one of two states. The states may be represented as {−1,1} (or {0,1} in a digital system) and may correspond to spin, where −1 indicates a spin in a first direction and 1 indicates a spin in the opposite direction.

One problem that an Ising system might solve could be to search for optimal solutions to a Boolean logic or arithmetic function when partial information about some inputs or outputs is known. Take, for example, an arithmetic problem of multi-bit multiplications. Unfortunately, existing techniques are limited for designing an Ising system for multi-bit multiplication. Finding an optimal Ising system for multi-bit multiplication involves polynomial feasibility problems. It would be desirable to have a computationally efficient technique for solving these polynomial feasibility problems to design useful systems for Ising model applications.

In some aspects of the present disclosure, a fast-multidimensional global polynomial solver (FM-GPS) may be applied in combination with linear programming techniques and dimension-reduction techniques to identify appropriate Hamiltonian parameters for obtaining optimal Ising spin-glass energy profiles for specific Hamiltonian systems modeled for performing Boolean logic operations and arithmetic functions. These aspects provide a platform for creating optimal Hamiltonians for other kinds of circuits, reflecting more complex Ising architecture constraints and algorithm objectives, e.g., a new compiler for this new physical computing technology.

The problem of performing multiplications using an Ising model can be formulated as follows: consider input bits s^{(x)},s^{(y)}, output bits s^{(o)}=^{z}, and auxiliary bits s^{(a)}(sⁱ). The auxiliary bits s^{(a)} may depend on input bits s⁽ⁱ⁾=(s^{(x)}, s^{(y)}) but not on output bits s^{(o)}=s^{(z)}. The notation s=(s^{(x)}, s^{(y)}, s^{(z)}) denotes general bit sequences, excluding auxiliary bits. Sub-indices sₙ represent the n^{th} element of a vector and super-indices s^{k} represent multi-index based products, e.g., s^{k}=Πᵢ^{s}sᵢ^{k}^{ₖ}. The parameter S_{cor} is the set of correct bit sequences, while Sᵢₙ, is the set of incorrect bit sequences. For instance, the bit sequence (−1, 1, −1) for the bitwise multiplication of spins −1 and 1 is correct, while (−1,1,1) is incorrect. Then, the problem can be expressed as:

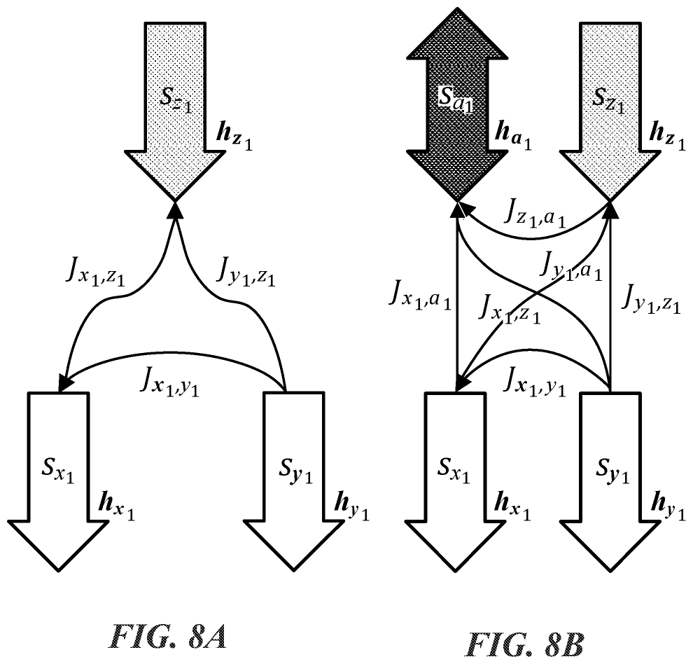

Find (h, J) such that H(s_{cor}; h, J)+1≤H(s_{inc}; h,J)∀(s_{cor}, s_{inc})∈S_{cor}×S_{inc}, (P0)

where the Hamiltonian H(s; h, J) =h^{T}s+s^{T}J s; for state s. The parameters h are linear parameters of the Ising model and the parameters J are the interaction terms of the Ising model. The Hamiltonian may also be referred to as the energy level. For every possible case, the correct answer should correspond to the spin output configuration with lowest energy. FIG. 8A illustrates an Ising spin-glass model without auxiliary variables, in accordance with aspects of the present disclosure. As seen in FIG. 8A, the elements Sₓ, S_{y}, and S_{z} represent bits from the input (x, y) and output (z). Hamiltonian parameters are shown as the J and h parameters. More specifically, a first Hamiltonian parameter hₓ₁ corresponds to a first input bit Sₓ₁, a second Hamiltonian parameter h_{y1} corresponds to a second input bit S_{y1}, and a third Hamiltonian parameter h_{z1} corresponds to an output bit S_{z1}. A first pairwise interaction J_{x1,z1} is illustrated between the input bit Sx₁ and the output bit Sz₁. A second pairwise interaction J_{y1,z1} is illustrated between the input bit Sy₁ and the output bit Sz₁. A third pairwise interaction J_{x1,y1} is illustrated between the input bit Sx₁ and the input bit Sy₁. The Ising spin-glass model of FIG. 8A corresponds to the Hamiltonian seen in problem P0.

To ensure the feasibility of such systems for multiplications beyond two bits, however, it may be necessary to introduce auxiliary variables. In this case, the system becomes:

$$\tilde{H} ( s , {s}^{( a )} ( {s}^{( i )} ) ; \tilde{h} , \tilde{J} ) = {\tilde{h}}^{T} [ \begin{matrix}s \\ {s}^{( a )} ( {s}^{( i )} )\end{matrix} ] + [ {s}^{T} , {s}^{{( a )}^{T}} ( {s}^{( i )} ) ] \tilde{J} [ \begin{matrix}s \\ {s}^{( a )} ( {s}^{( i )} )\end{matrix} ] = H ( s ; h , J ) + {\sum }_{n} {h}_{n}^{( a )} {s}_{n}^{( a )} ( {s}^{( i )} ) + 2 {\sum }_{m , n} {J}_{m , n}^{( a , x )} {s}_{m} {s}_{n}^{( a )} ( {s}^{( i )} ) + {\sum }_{m , n} {J}_{m , n}^{( a , a )} {s}_{m}^{( a )} ( {s}^{( i )} ) {s}_{n}^{( a )} ( {s}^{( i )} ) , \qquad ( 16 )$$

$$where ,$$

$$\tilde{h} = [ \begin{matrix}h \\ {h}^{( a )}\end{matrix} ] , \tilde{J} - [ \begin{matrix}J & {J}^{( s , a )} \\ {J}^{{( s , a )}^{T}} & {J}^{( a , a )}\end{matrix} ]$$

FIG. 8B illustrates an Ising spin-glass model with auxiliary variables, in accordance with aspects of the present disclosure. The Ising spin-glass model of FIG. 8B corresponds to the generalized Hamiltonian system shown in Equation (16). As seen in FIG. 8B, the elements Sₓ, S_{y}, S_{z}, and Sₐ represent bits from the input (x, y) output (z), and auxiliary bits. Hamiltonian parameters are shown as the J and h parameters. More specifically, a first Hamiltonian parameter hₓ₁ corresponds to a first input bit Sₓ₁, a second Hamiltonian parameter h_{y1} corresponds to a second input bit S_{y1}, a third Hamiltonian parameter h_{z1} corresponds to an output bit S_{z1}, and a fourth Hamiltonian parameter hₐ₁ corresponds to an auxiliary bit Sₐ₁. A first pairwise interaction J_{x1,z1} is illustrated between the input bit Sx₁ and the output bit Sz₁. A second pairwise interaction J_{y1,z1} is illustrated between the input bit Sy₁ and the output bit Sz₁. A third pairwise interaction J_{x1,y1} is illustrated between the input bit Sx₁ and the input bit Sy₁. A fourth pairwise interaction J_{x1,a1} is illustrated between the input bit Sx₁ and the auxiliary bit Sa₁. A fifth pairwise interaction J_{y1,a1} is illustrated between the input bit Sy₁ and the auxiliary bit Sa₁. A sixth pairwise interaction J_{z1,a1} is illustrated between the output bit Sz₁ and the auxiliary bit Sa₁. This more complex form involves polynomial equations of degree three. Current techniques for solving the polynomial feasibility problem in this case are based on simplifications and the use of integer linear programming (ILP), linear programming (LP), and quadratically constrained quadratic program (QCQP) software in conjunction with various (often exponential) search methodologies. In the current solutions, the auxiliary variables s^{(a)} in Equation (16) are fixed, leading to a linear system in the remaining variables that is solved using a large-scale LP solver.

Another approach is to let all variables vary, but to omit the interactions among the auxiliary variables, leading to a QCQP or mixed ILP solution, depending on the approach. These approaches have proven successful for addressing multiplications up to four bits, but they possess multiple drawbacks that have impeded their use beyond four bits. For example, these techniques have an exponential computational cost. That is, exploring the entire search space by fixing auxiliary variables incurs an exponential number of possibilities, each of which involves the solution of a large, expensive LP problem. QCQP problems are NP-hard and although efficient heuristics are available in some cases, they remain very expensive to solve, and exponentially expensive in the worst cases. In both cases, such approaches become computationally intractable as the problem sizes increase.

Existing solutions that neglect auxiliary variable interactions significantly reduce the explored portion of the search space, and are likely to lead to sub-optimal outcomes. In the most general form of Equation (16), the problem is a degree-three (e.g., non-convex) polynomial feasibility problem. Existing techniques for addressing these problems offer a trade-off between computational efficiency and a guarantee of success. Neither is acceptable.

Aspects of the present disclosure overcome all three of these barriers through the use of FM-GPS techniques in combination with dimension-reduction techniques based on non-linear multidimensional polynomial interpolation, and linear programming.

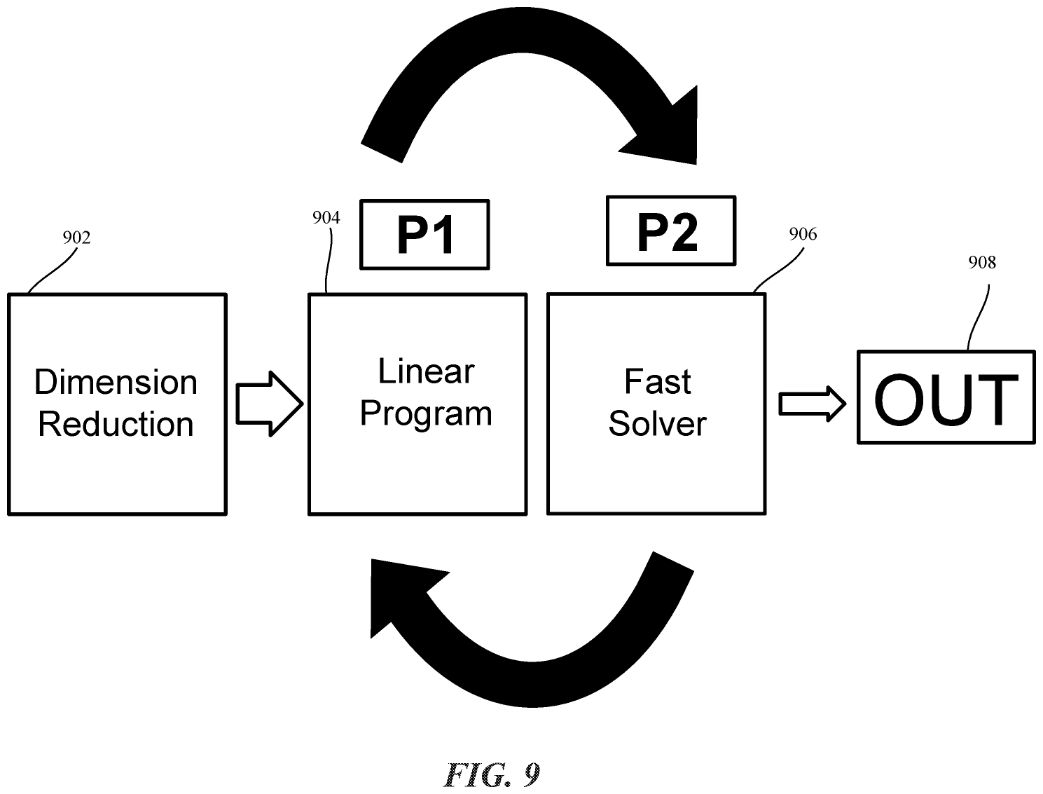

FIG. 9 is a block diagram illustrating an approach for solving an Ising system, in accordance with aspects of the present disclosure. In FIG. 9, at block 902, dimension reduction is applied to a polynomial feasibility problem (e.g., Equation (16)), for example, with a multidimensional polynomial neural network (MPNN). The polynomial feasibility problem represents a physical system for solving a computational problem. The dimension reduction reduces dimensions of the polynomial feasibility problem by transforming the polynomial feasibility problem into two separate feasibility problems: a high-dimensional linear feasibility problem (P1) and a non-linear feasibility problem (P2), each of which is described in more detail below. A simultaneous solution of the two feasibility problems corresponds to a solution of the original problem.

At block 904, the high-dimensional linear feasibility problem is solved to obtain a first set of interim solutions. The first set may include one or more interim solutions. The high-dimensional linear feasibility problem may be solved, for example, with linear programming techniques. At block 906, the non-linear feasibility problem is solved based on the first set of interim solutions to obtain a result of the non-linear feasibility problem. Fast solvers, e.g., the FM-GPS, may be employed for the non-linear feasibility problem. If a solution is obtained, at block 908, parameters characterizing the physical system are output, with a ground state corresponding to an output solution of the computational problem based on the result of the non-linear feasibility problem.

When no result is obtained for the non-linear solution at block 906, the process iterates back to block 904 for solving the linear feasibility problem to obtain a second set of interim solutions. Auxiliary bits may be added to the polynomial feasibility problem when iterating back to solving the linear feasibility problem at block 904.

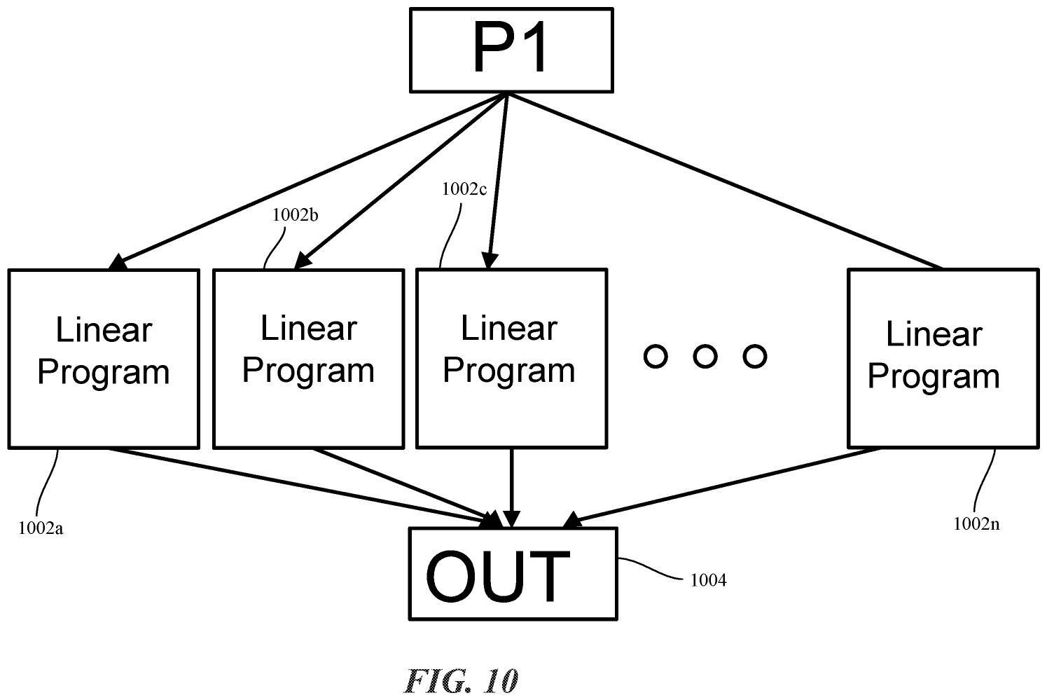

FIG. 10 is a block diagram illustrating solving of a high-dimensional linear feasibility problem with linear programs, in accordance with aspects of the present disclosure. Generally speaking, at blocks 1002a, 1002b, . . . 1002n, linear programming techniques are applied to Problem (P1), which is described in detail below. A result of the linear programming is output at block 1004. More specifically, FIG. 10 illustrates the linear programming portion of the method, after the original problem is split into a high-dimensional linear feasibility problem and a non-linear feasibility problem. The Problem (P1) represents the high-dimensional linear feasibility problem. The multiple arrows from the Problem (P1) to the blocks 1002a, 1002b, . . . 1002n indicate that multiple feasible solutions may be computed in parallel. Each block 1002a, 1002b, . . . 1002n represents a different instances of a linear program (e.g., minimizing a linear functional on a polyhedron). As seen by the arrows from each block 1002a, 1002b, . . . 1002n to the output 1004, all solutions obtained in parallel may be fed and used simultaneously by the a non-linear problem solver.

The techniques of the present disclosure possess advantages, such as scalability, efficient searching, and guarantees. Scalability is achieved because each sub-problem (e.g., the high-dimensional linear feasibility problem and the non-linear feasibility problem) can be addressed in a scalable fashion. The high-dimensional linear feasibility problem can be addressed through a mixture of the alternating projection algorithm and existing highly-efficient linear programming solvers. The non-linear feasibility problem can be treated using the FM-GPS techniques.

The techniques of the present disclosure have an advantage that all interactions between auxiliary variables can be taken into consideration. Further, information gathered at each step is not discarded (as with a discrete search), but rather used to inform the next step and improve the efficiency of the search. Finally, the use of a non-linear MPNN-based search strategy implies an efficient search of the space.

The non-convex nature of the general problem makes the establishment of global feasibility elusive. Aspects of the present disclosure, however, overcome this issue. Indeed, given a desired accuracy level E, the disclosed novel techniques can find a feasible point when such a point exists.

In general, the novel technique is capable of treating spin-glass multiplication problems with 100,000,000 spin sequence constraints and hundreds of auxiliary spins. The method is also capable of treating more general operations, such as addition or logical operations (e.g., XOR, AND, etc.) of interest to linear programming solvers, and can lead to more efficient implementations (e.g., more compact Hamiltonians). This can be a platform for building a more general “compiler technology” for circuits that takes into account architectural objectives such as topology or precision. With a number of new physical computing systems emerging for rapidly solving Ising systems (e.g., classically based on photons and quantum based on Rydberg atoms or Polaritons), this capability may bridge multiple types of applications to these new computers.

Aspects of the present disclosure rely on proven technology (e.g., LP solvers) as well as recently developed technology for global optimization of (including determining feasibility) polynomial systems (e.g., FM-GPS), used in conjunction with dimension-reduction techniques from the field of neural networks. To obtain a simultaneous solution, one must find a point within the intersection of a complex convex polytope (Problem (P1)) and a low-degree algebraic set (Problem (P2)). For efficiency purposes, the polytope is approximated incrementally with the goal of finding a simple, yet sufficient, vertex-represented approximation for computing a solution without having to construct the entire (likely very complex) polytope. As such, stopping criteria may be determined at runtime, and estimates on the number of required (outer) iterations are yet unknown. Aspects of the present disclosure address the trade-off between the size of the dimension-reduced sub-problems, and a complete visit of the search space. Indeed, as explained below, the dimension reduction scheme is equivalent to visiting a non-linear submanifold portion of the entire space. Multiple sub-problems imply multiple submanifolds, and an efficient search of the entire space may only be completed if the union of these manifolds intersects with the feasible set.

A more detailed technical description is now provided. Following the formulation of Problem (P0) combined with the addition of auxiliary variables (e.g., Equation (16)), the problem of interest takes the form:

Find (\tilde{h},\tilde{J},s^{(a)}(s⁽ⁱ⁾)) such that \tilde{H}(s_{cor}, s^{(a)}(s⁽ⁱ⁾); \tilde{h},\tilde{J})+1≤\tilde{H}(s_{inc}, s^{(a)}(s⁽ⁱ⁾); \tilde{h},\tilde{J})∀(s_{cor}, s_{inc})∈S_{cor}×S_{inc}s^{(a)}(s^{(i)∈{-}1,1}, (P0)

note that s_{cor}⁽ⁱ⁾=s_{inc}⁽ⁱ⁾=s⁽ⁱ⁾ by construction. Any feasible solution to Problem (P0) will provide a viable Ising computation model for the task at hand. The goal is to find such a solution, or to determine that a solution does not exist.

The FM-GPS addresses problems of the feasibility form. The FM-GPS is concerned with global polynomial optimization, from which feasibility problems can be obtained.

Find x∈ [symbol] ^{D} subject to qₙ(x)≥0,n=1,2, . . . , N rₘ(x)=0, m=1,2, . . . , M, (17)

where {qₙ(x)}, {rₘ(x)} are polynomial constraints. This generic form can easily be adapted to represent Problem (P2). Fundamentally, the crux of the FM-GPS is a semi-definite relaxation of the original non-convex problem which takes the form:

Find {μₙ} such that M(μₙ)≥0, (18)

where M(μₙ) is a (moment) matrix whose explicit form is specific to the framework and the constraint polynomials, and ≥0 indicates positive-definiteness. This problem is a semi-definite program and is convex. In particular, many existing techniques can be used to solve the latter. Numerical experiments have shown that, in a large array of cases, the size of M(19 ) need only be slightly larger than the maximum number of non-zero coefficients in each constraint polynomial. In some examples, it may be sufficient to pick the size of M(·) to be merely polynomial in dimension whenever the set defined by the constraints is bounded.

Dimensionality reduction in Problem (P0) is specified because the number of inequalities present in the problem involves a number of independent auxiliary variables proportional to the number of input sequences, which in turn is exponential in the number of input bits. As such, the dimensionality of the problem may become large very quickly, leading to intractable computations. To reduce such costs, aspects of the present disclosure employ a dimensionality reduction technique based on a multidimensional polynomial neural network (MPNN). An MPNN is a neural network for which the activation functions correspond to polynomials. After simplification, the MPNN can be written in the form.

$$π ( x ; w ) = {\sum }_{k} {π}_{k} ( w ) {x}^{k} \qquad ( 19 )$$

where the polynomial coefficients πₖ(w) are themselves polynomials in the network weights w, and can be efficiently evaluated. It is noted that multi-index notation, e.g., x^{k}=Πᵢxᵢ^{k}^{ᵢ} is used in Equation (19). The exact nature of the polynomials depends on the structure of the network used. The degree of πₖ (w) depends on the degree of the activation functions together with the depth of the network, while the domain dimension corresponds to the number of weights w. These functions are well-suited for representing complex high-dimensional functions efficiently. In this context, the MPNN is used to reduce the dimension of the auxiliary variables. That is, the MPNN re-expresses the auxiliary variables s^{(a)} as:

$${s}^{( a )} ( {s}^{( i )} ) = {\sum }_{k} {σ}_{k} ( w ) {( {s}^{( i )} )}^{k} \qquad ( 20 )$$

where σₖ is an intermediary parameter to represent the relationship between the input bits and the auxiliary bits.

The Ising variables h and j may also be expressed in this fashion if deemed appropriate. For component-wise notation, write: sₙ^{(a)}(s⁽ⁱ⁾)=Σₖ₌₁^{K}σ_{k,n}(w)(s⁽ⁱ⁾)^{k}. Substitution in Equation (16) leads to a Hamiltonian of the form:

$$\tilde{H} ( s , {s}^{( a )} ( {s}^{( i )} ) ; \ddot{h} , \ddot{J} ) = H ( s ; h , J ) + {\sum }_{k} {( {s}^{( i )} )}^{k} ( {\sum }_{n} {h}_{n}^{( a )} {σ}_{k , n} ( w ) ) + 2 {\sum }_{k} {\sum }_{m} {( {s}^{( i )} )}^{k} {s}_{m} ( {\sum }_{n} {J}_{m , n}^{( a , s )} {σ}_{k , n} ( w ) ) + {\sum }_{k , l} {( {s}^{( i )} )}^{k + l} ( {\sum }_{m , n} {J}_{m , n}^{( a , a )} ( {σ}_{k , m} ( w ) {σ}_{l , n} ( w ) ) ) \qquad ( 21 )$$

For each fixed bit sequence, this Hamiltonian corresponds to a polynomial in the variables \tilde{h}, \tilde{J} and weights w. Upon reformulating Problem (P0) in these variables, a new polynomial feasibility problem of higher degree than the original is obtained, but of significantly lower dimension. This reformulation, in fact, corresponds to solving the original problem on a lower-dimensional algebraic sub-manifold lying in the original search space, analogous to a space-filling curve. This approach offers a trade-off between computational efficiency (e.g., degree, dimension, and size of feasibility problem) and the portion of search space that is being explored. By choosing the MPNN appropriately, the search sub-manifold generated will intersect the original feasible set so that a solution may be found by solving the new problem. Coupled with FM-GPS, this approach leads to semi-definite programs (SDPs) with a computationally advantageous block structure reduced in size compared with the original problem by orders of magnitude. Further, both the block structure and the choice of MPNN offer opportunities for parallelization.

Technical details are now provided for the previously discussed computationally efficient formulation of the Ising spin-glass problem. Aspects of the present disclosure rely on the introduction of two feasibility problems for which any simultaneous solution corresponds to a solution of the problem of interest:

Problem (P1): A large linear programming (LP) feasibility problem (also referred to as a high-dimensional linear feasibility problem); and

Problem (P2): A small non-linear polynomial feasibility problem (also referred to as a non-linear feasibility problem).

Problem (P1) is obtained by re-expressing the non-linear terms in Equation (16) through new variables, while Problem (P2) corresponds to the feasibility of the change of variables itself. This formulation is highly-advantageous from a computational standpoint. Indeed, Problem (P1) involves many constraints but is linear; meanwhile, Problem (P2) is non-linear but relatively small (e.g., lower dimension, degree, and number of constraints). Large-scale linear feasibility solvers (e.g., alternating projections and Google's linear programming system (GLOP)) may be employed in the first case, and the FM-GPS technology may be employed in the second case. Leveraging the strength of each tool in their respective realms leads to a level of scalability unachievable with the original non-linear formulation, or existing computational tools.

To obtain Problems (P1) and (P2), proceed as follows, first, introduce:

$$\tilde{K} ( s ; \tilde{h} , \tilde{J} , η , γ , ξ ) = H ( s ; h , J ) + {\sum }_{k} {( {s}^{( i )} )}^{k} {η}_{k} + 2 {\sum }_{k} {\sum }_{m} ( {( {s}^{( i )} )}^{k} {s}_{m} ) {γ}_{k , m} + {\sum }_{k , l} {( {s}^{( i )} )}^{k + l} {ξ}_{k , l ,} \qquad ( 22 )$$

which corresponds to the dimension-reduced Hamiltonian \tilde{H}(·) in Equation (21) after proceeding to a change of variables in the non-linear terms, for example:

$${η}_{k} = {\sum }_{n} {h}_{n}^{( a )} {σ}_{k , n} ( w ) , {γ}_{k , m} {\sum }_{n} {J}_{m , n}^{( a , s )} {σ}_{k , n} ( w ) ,$$

$${ξ}_{k , l ,} = {\sum }_{m , n} {J}_{m , n}^{( a , a )} {σ}_{k , m} ( w ) {σ}_{l , n} ( w )$$

Following this, find that (\tilde{h}, \tilde{J}, s^{(a)}) is a solution of the original problem (with auxiliary variables; PO+Equation (16)) if it is a simultaneous solution of the following two problems:

Find (\tilde{h}, \tilde{J}, η, γ, ξ) such that \tilde{K}(s_{cor}; \tilde{h}, \tilde{J}, η, γ, ξ)+1≤\tilde{K}(s_{inc}; \tilde{h}, \tilde{J}, η, γ, ξ) V(s_{cor}, s_{inc})∈S_{cor}×S_{inc} (P1)
Find (h^{(a)}, J^{(s,a)}, J^{(a,a)}, w) such that

$${\sum }_{n} {h}_{n}^{( a )} {σ}_{k , n} ( w ) = {η}_{k} \qquad ( P2 )$$

$${\sum }_{n} {J}_{m , n}^{( a , s )} {σ}_{k , n} ( w ) = {γ}_{k , m}$$

$${\sum }_{m , n} {J}_{m , n}^{( a , a )} {σ}_{k , m} ( w ) {σ}_{l , n} ( w ) = {ξ}_{k , l ,}$$

$${s}^{( a )} ( {s}^{( i )} ) = {\sum }_{k = 1}^{K} {σ}_{k} ( w ) {( {s}^{( i )} )}^{k} ϵ \{ - 1 , 1 \} ∀ i \qquad ( 23 )$$

This is the desired reformulation. To find a solution, iteratively alternate between Problem (P1) and Problem (P2) until a solution is found (or no solution is deemed to exist) as follows:

Step (S1): Solve Problem (P1). Multiple instances of this step can be performed quickly in parallel.

Step (S2): Solve Problem (P2) for (\tilde{h},\tilde{J},η,γ,ζ) inside the convex set generated by all previously computed solutions of Problem (P1) (Step (S1)).

Step (S3): If a solution is found, terminate the process and return. Otherwise, return to Step (S1). By doing so, the size of the search space is incrementally increased while keeping the dimension and processing cost of solving each polynomial feasibility Problem (P2) under control. This process ultimately converges to the full polytope, but the process is stopped as soon as a solution is found.

Aspects of the present invention may enable building more complex optimization objectives, including adding optimization objectives to limit the dynamic range and precision requirements of Hamiltonian coupling parameters to improve the performance (e.g., robustness to noise, reduced solution integration time) of the resulting circuit. Aspects may also enable adding optimization objectives to drive the resulting Hamiltonian toward sparsity (e.g., reducing the number of couplings) and routability (e.g., preferring coupling topologies that are planar) to improve implementability of the Hamiltonian on physical hardware. Aspects of the present disclosure may also enable a more general circuit mapping and synthesis capability, including known arithmetic algorithm (e.g., Wallace Trees, Booth Encoding, Fourier Transforms) idioms to speed results.

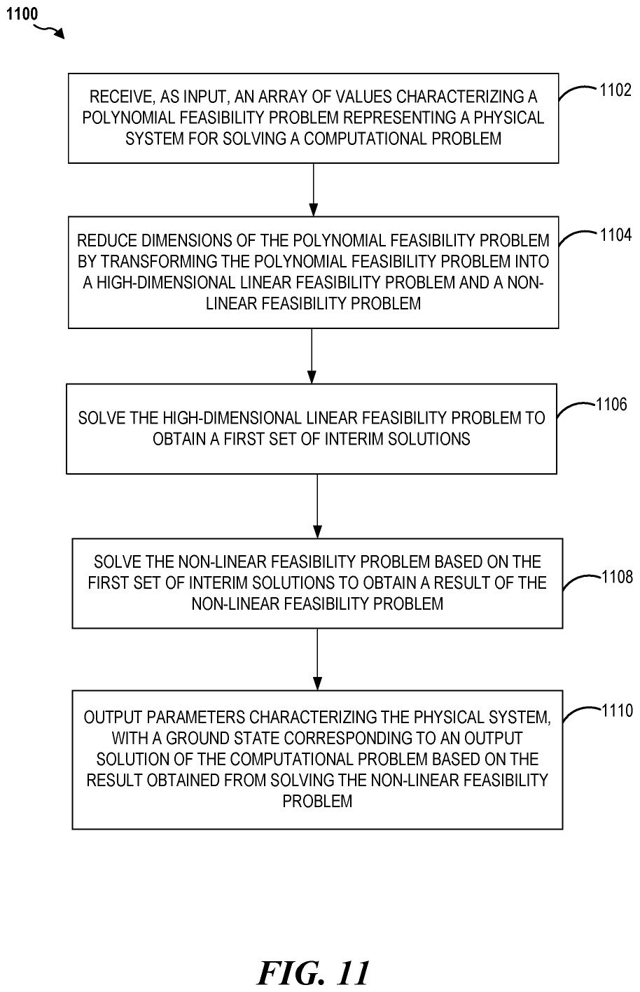

FIG. 11 illustrates a method 1100 for efficient computation of Hamiltonians for Ising processors, in accordance with aspects of the present disclosure. As shown in FIG. 11, the method 1100 may include receiving, as input, an array of values characterizing a polynomial feasibility problem representing a physical system for solving a computational problem (block 1102). In some aspects, the physical system is described by a parameterized Hamiltonian function. The parameterized Hamiltonian function belongs to an Ising family of Hamiltonians. The computational problem may be multiple bit multiplication, multi-bit addition, or a Boolean operation.

The method 1100 may include reducing dimensions of the polynomial feasibility problem by transforming the polynomial feasibility problem into a high-dimensional linear feasibility problem and a non-linear feasibility problem (block 1104). The method 1100 may include solving the high-dimensional linear feasibility problem to obtain a first set of interim solutions (block 1106). In some aspects, the high-dimensional linear feasibility problem is solved using an alternating projections method or with a linear program.

The method 1100 may include solving the non-linear feasibility problem based on the first set of interim solutions to obtain a result of the non-linear feasibility problem (block 1108). In some aspects, fast solvers, e.g., the FM-GPS, may be employed for the non-linear feasibility problem.

The method 1100 may include outputting parameters characterizing the physical system, with a ground state corresponding to an output solution of the computational problem based on the result obtained from solving the non-linear feasibility problem (block 1110). In some aspects, the output solution corresponds to a state of the physical system with lowest energy.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

### EXAMPLE ASPECTS

Aspect 1: A processor-implemented method, comprising: receiving, as input, an array of values characterizing a polynomial feasibility problem representing a physical system for solving a computational problem; reducing dimensions of the polynomial feasibility problem by transforming the polynomial feasibility problem into a high-dimensional linear feasibility problem and a non-linear feasibility problem; solving the high-dimensional linear feasibility problem to obtain a first set of interim solutions; solving the non-linear feasibility problem based on the first set of interim solutions to obtain a result of the non-linear feasibility problem; and outputting parameters characterizing the physical system, with a ground state corresponding to an output solution of the computational problem based on the result obtained from solving the non-linear feasibility problem.

Aspect 2: The method of Aspect 1, in which the output solution corresponds to a state of the physical system with lowest energy.

Aspect 3: The method of Aspect 1 or 2, in which the physical system is described by a parameterized Hamiltonian function.

Aspect 4: The method of any of the preceding Aspects, in which the parameterized Hamiltonian function belongs to an Ising family of Hamiltonians.

Aspect 5: The method of any of the preceding Aspects, in which solving the high-dimensional linear feasibility problem comprises using an alternating projections method or solving a linear program.

Aspect 6: The method of any of the preceding Aspects, further comprising iterating back to solving the high-dimensional linear feasibility problem to obtain a second set of interim solutions, when no result is obtained for the non-linear feasibility problem.

Aspect 7: The method of any of the preceding Aspects, further comprising adding auxiliary bits to the polynomial feasibility problem after iterating back to solving the high-dimensional linear feasibility problem.

Aspect 8: The method of any of the preceding Aspects, in which the computational problem comprises multiple bit multiplication, multi-bit addition, or a Boolean operation.

Aspect 9: An apparatus, comprising: a memory; and at least one processor coupled to the memory, the at least one processor configured: to receive, as input, an array of values characterizing a polynomial feasibility problem representing a physical system for solving a computational problem; to reduce dimensions of the polynomial feasibility problem by transforming the polynomial feasibility problem into a high-dimensional linear feasibility problem and a non-linear feasibility problem; to solve the high-dimensional linear feasibility problem to obtain a first set of interim solutions; to solve the non-linear feasibility problem based on the first set of interim solutions to obtain a result of the non-linear feasibility problem; and to output parameters characterizing the physical system, with a ground state corresponding to an output solution of the computational problem based on the result obtained from solving the non-linear feasibility problem.

Aspect 10: The apparatus of Aspect 9, in which the output solution corresponds to a state of the physical system with lowest energy.

Aspect 11: The apparatus of Aspect 9 or 10, in which the physical system is described by a parameterized Hamiltonian function.

Aspect 12: The apparatus of any of the Aspects 9-11, in which the parameterized Hamiltonian function belongs to an Ising family of Hamiltonians.

Aspect 13: The apparatus of any of the Aspects 9-12, in which the high-dimensional linear feasibility problem is solved using an alternating projections method or solving a linear program.

Aspect 14: The apparatus of any of the Aspects 9-13, in which the at least one processor is further configured to solve the high-dimensional linear feasibility problem to obtain a second set of interim solutions, when no result is obtained for the non-linear feasibility problem.

Aspect 15: The apparatus of any of the Aspects 9-14, in which the at least one processor is further configured to add auxiliary bits to the polynomial feasibility problem after iterating back to solving the high-dimensional linear feasibility problem.

Aspect 16: The apparatus of any of the Aspects 9-15, in which the computational problem comprises multiple bit multiplication, multi-bit addition, or a Boolean operation.

Aspect 17: An apparatus, comprising: means for receiving, as input, an array of values characterizing a polynomial feasibility problem representing a physical system for solving a computational problem; means for reducing dimensions of the polynomial feasibility problem by transforming the polynomial feasibility problem into a high-dimensional linear feasibility problem and a non-linear feasibility problem; means for solving the high-dimensional linear feasibility problem to obtain a first set of interim solutions; means for solving the non-linear feasibility problem based on the first set of interim solutions to obtain a result of the non-linear feasibility problem; and means for outputting parameters characterizing the physical system, with a ground state corresponding to an output solution of the computational problem based on the result obtained from solving the non-linear feasibility problem.

Aspect 18: The apparatus of Aspect 17, in which the output solution corresponds to a state of the physical system with lowest energy.

Aspect 19: The apparatus of Aspect 17 or 18, in which the physical system is described by a parameterized Hamiltonian function.

Aspect 20: The apparatus of any of the Aspects 17-19, in which the parameterized Hamiltonian function belongs to an Ising family of Hamiltonians.

As used, the term “ determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer- readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
receiving, as input, an array of values characterizing a polynomial feasibility problem representing a physical system for solving a computational problem;
reducing dimensions of the polynomial feasibility problem by transforming the polynomial feasibility problem into a high-dimensional linear feasibility problem and a non-linear feasibility problem;
solving the high-dimensional linear feasibility problem to obtain a first set of interim solutions;
solving the non-linear feasibility problem based on the first set of interim solutions to obtain a result of the non-linear feasibility problem; and
outputting parameters characterizing the physical system, with a ground state corresponding to an output solution of the computational problem based on the result obtained from solving the non-linear feasibility problem.

2. The method of claim 1, in which the output solution corresponds to a state of the physical system with lowest energy.

3. The method of claim 2, in which the physical system is described by a parameterized Hamiltonian function.

4. The method of claim 3, in which the parameterized Hamiltonian function belongs to an Ising family of Hamiltonians.

5. The method of claim 1, in which solving the high-dimensional linear feasibility problem comprises using an alternating projections method or solving a linear program.

6. The method of claim 1, further comprising iterating back to solving the high-dimensional linear feasibility problem to obtain a second set of interim solutions, when no result is obtained for the non-linear feasibility problem.

7. The method of claim 6, further comprising adding auxiliary bits to the polynomial feasibility problem after iterating back to solving the high-dimensional linear feasibility problem.

8. The method of claim 1, in which the computational problem comprises multiple bit multiplication, multi-bit addition, or a Boolean operation.

9. An apparatus, comprising:
a memory; and
at least one processor coupled to the memory, the at least one processor configured:
to receive, as input, an array of values characterizing a polynomial feasibility problem representing a physical system for solving a computational problem;
to reduce dimensions of the polynomial feasibility problem by transforming the polynomial feasibility problem into a high-dimensional linear feasibility problem and a non-linear feasibility problem;
to solve the high-dimensional linear feasibility problem to obtain a first set of interim solutions;
to solve the non-linear feasibility problem based on the first set of interim solutions to obtain a result of the non-linear feasibility problem; and
to output parameters characterizing the physical system, with a ground state corresponding to an output solution of the computational problem based on the result obtained from solving the non-linear feasibility problem.

10. The apparatus of claim 9, in which the output solution corresponds to a state of the physical system with lowest energy.

11. The apparatus of claim 10, in which the physical system is described by a parameterized Hamiltonian function.

12. The apparatus of claim 11, in which the parameterized Hamiltonian function belongs to an Ising family of Hamiltonians.

13. The apparatus of claim 9, in which the high-dimensional linear feasibility problem is solved using an alternating projections method or solving a linear program.

14. The apparatus of claim 9, in which the at least one processor is further configured to solve the high-dimensional linear feasibility problem to obtain a second set of interim solutions, when no result is obtained for the non-linear feasibility problem.

15. The apparatus of claim 14, in which the at least one processor is further configured to add auxiliary bits to the polynomial feasibility problem after iterating back to solving the high-dimensional linear feasibility problem.

16. The apparatus of claim 9, in which the computational problem comprises multiple bit multiplication, multi-bit addition, or a Boolean operation.

17. An apparatus, comprising:
means for receiving, as input, an array of values characterizing a polynomial feasibility problem representing a physical system for solving a computational problem;
means for reducing dimensions of the polynomial feasibility problem by transforming the polynomial feasibility problem into a high-dimensional linear feasibility problem and a non-linear feasibility problem;
means for solving the high-dimensional linear feasibility problem to obtain a first set of interim solutions;
means for solving the non-linear feasibility problem based on the first set of interim solutions to obtain a result of the non-linear feasibility problem; and
means for outputting parameters characterizing the physical system, with a ground state corresponding to an output solution of the computational problem based on the result obtained from solving the non-linear feasibility problem.

18. The apparatus of claim 17, in which the output solution corresponds to a state of the physical system with lowest energy.

19. The apparatus of claim 18, in which the physical system is described by a parameterized Hamiltonian function.

20. The apparatus of claim 19, in which the parameterized Hamiltonian function belongs to an Ising family of Hamiltonians.
